(19) United States
(12) Patent Application Publication
(10) Pub. No.: US 2002/0123962 A1
(43) Pub. Date: Sep. 5, 2002

(54) System and method for providing a reaffirmation credit card including an increasing credit limit

(76) Inventors: Evan L. Bryman, Richmond, VA (US); Aaron A. Fidler, Glen Allen, VA (US); Ethan E. Chandler, Richmond, VA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/796,461

(22) Filed: Mar. 2, 2001

(51) Int. Cl. G06F 17/60

(52) U.S. Cl. 705/39

(57) ABSTRACT

A system and method is provided to manage a reaffirmation credit card account associated with an outstanding debt of a user. The reaffirmation credit card account includes a credit line account record, providing an available credit up to a credit limit, and a pre-existing debt account record. The outstanding debt of the user is transferred to the pre-existing debt account record. When a payment to the reaffirmation credit card account is received from the user, the payment is allocated between the credit line account record and the pre-existing debt account record, based on predetermined allocation criteria. The amount of available credit in the credit line account record is increased, based on whether the received payment or series of payments satisfies predetermined payment criteria.

### BACKGROUND OF THE INVENTION

1. Field of the Invention

The present invention generally relates to debt recovery and, more particularly, to systems and methods for providing reaffirmation credit cards with an increasing credit limit.

2. Description of the Related Art

Credit issuing businesses of all sizes and types sometimes have problems with customers who are delinquent in paying off debt. Non-payment of debt, such as credit card debt, has cost businesses billions of dollars in revenue. Most credit issuers do not wait for delinquent customers to pay their debt. Instead, to recover all or a portion of the debt, they usually employ various tactics to collect payments from their customers.

Many credit issuers initially make an effort to collect overdue payments using some type of reminder, such as a letter or a phone call. Initial efforts are usually non-confrontational in case there has been a misunderstanding, such as the customer erroneously believing that all debt was previously paid or the credit issuer not receiving payments that actually were sent by the customer. A credit issuer often will receive payments from some customers in response to such a reminder. However, for other customers, the reminder will not be sufficient and their debts will remain unpaid.

Accounts that remain overdue for a lengthy period may be designated as a charged-off account. A charged-off account is an account on which a customer has not made a payment for a predetermined time period. Credit issuers consider charged-off accounts “written off” from their books (e.g., no longer receivable). Credit issuers may continue to attempt collection on charged-off accounts, but customers may no longer use the account to create further debt.

If initial collection efforts fail, some credit issuers resort to using debt collection agencies to collect payments from delinquent customers. For example, a credit issuer may give a number of charged-off or delinquent accounts to an agency, while retaining ownership of the accounts. When customers provide payments to the agency, the agency keeps a percentage (e.g., 50%) and forwards the remainder to the credit issuer. Credit issuers may also try selling a portfolio of charged-off accounts to an agency. Under this arrangement, agencies essentially buy portfolios for a fraction of the debt amount (e.g., less than one cent per dollar) and attempt collection. Accordingly, a customer then owes the debt-collecting agency instead of the original credit issuing business. However, the practice of buying portfolios of charged-off debt comes with a risk, as there is a good chance that the customer will not pay.

One possible reason for a customer's non-willingness to pay is use of a repayment plan by the business that is unattractive to the customer. For example, the debt-holder may not offer any incentive for making repayments, other than repairing the customer's credit history or preventing further phone calls and other collection attempts. This is often insufficient to prod a number of customers into repayment. Other portion of repayment before the incentive becomes available. For example, a debt-holder may offer a repayment incentive to customers, but only upon full repayment of the debt. Satisfaction of the requirement may seem so unlikely or so distant to the customer that the incentive is not realistic. Moreover, other repayment plans may be unattractive to the business, not making it worth the risk of buying charged-off accounts and other debt. If the business offers too large an incentive to the customer who is being offered a repayment plan, the business risks losing money, even if the customer pays off a substantial portion of the debt. Regardless of whether the credit-issuer or a purchasing agency is the current debt-holder, their goal is to obtain payment from the customer.

One method debt-holders have used to entice customers to follow a repayment plan is the issuance of a reaffirmation credit card. Essentially, the customer “reaffirms” or acknowledges to the debt-holder that a debt is owed. The debt-holder issues the customer a credit card, and by making payments on the owed debt, the available credit increases. This is attractive to the customer, because the customer receives an incentive (a line of available credit on a credit card) for paying a pre-existing debt. In particular, the customer receives a line of available credit on a credit card in exchange for reaffirming the debt. Further, this is attractive to the debt-holder, because the debt-holder is receiving payments on an account that was charged-off.

Conventional reaffirmation credit cards typically work as follows. A debt-holder will offer a reaffirmation credit card to a customer with a pre-existing debt. If the customer accepts, the customer reaffirms the pre-existing debt in exchange for a account records, a pre-existing debt account record and a credit line account record. One-half of the pre-existing debt is placed into the pre-existing debt account record and the other half is placed into the credit line account record. The customer is then given a reaffirmation credit card with a maximum credit limit of one-half of the customer's pre-existing debt. However, the reaffirmation credit card initially has no available credit. While the maximum credit limit is one-half of the customer's pre-existing debt, one-half of that debt has been transferred to the credit line account, leaving an available balance of zero.

When the customer makes payments to the debt-holder, the payments are split between the pre-existing debt account record and the credit line account record, in proportion on the balances of those account records. (Fees and interest may also factor into the balances of the account records; however, for simplicity, fees and interest have been omitted from this discussion.) The customer realizes an available credit line as the balance of the credit line account record falls below the maximum credit limit. Thus, in the typical reaffirmation credit card, the customer will not realize a greater available line of credit than the amount of payments the customer has made to the credit line account record.

FIG. 1 illustrates an exemplary flow diagram of events in a conventional reaffirmation credit card system. For example, as shown in block 10, the customer has a pre-existing, charged-off debt of $1000. When the customer reaffirms the debt with the debt-holder, the debt-holder creates two account records. Into the first account record 12, the debt-holder transfers one-half of the customer's debt, or $500 in this the customer's debt, or $500. The initial amount transferred into the first account record 12 also represents the maximum available credit line for the customer. The customer's available credit line is then the maximum available credit less the outstanding debt associated with the first account record 12. In this example, the initial amount transferred into the first account record 12 is $500, and thus, $500 is the customer's maximum available credit line. However, because first account record 12 initially has a $500 outstanding debt, the customer's available credit is $0.

Block 20 corresponds to when the customer makes a payment of $200 to the debt-holder. The reaffirmation credit card system splits the payment between the two account records 12 and 14, such that the balance in each account record is $400. Because the customer's maximum available credit is $500 and the balance in account record 12 is now $400, the payment provides the customer with an available credit line of $100.

Similarly, as shown in block 30, if the customer then pays $400, the payment is split evenly between the account records 12 and 14, because each account record has the same balance prior to applying the payment. The balance in each account record after payment is $200. Because the customer's maximum available credit is $500 and the balance in account record 12 is now $200, the payment provides the customer with an available credit line of $300.

In block 40, the customer uses their reaffirmation credit card to charge $100 worth of goods, services, or other purchases (such as may be done using a conventional credit card). The customer's balance in account record 12 increases by $100 and available credit line decreases by the same. The other account record 14 is not affected by charges made with the reaffirmation credit card.

Block 50 illustrates another property of a conventional reaffirmation credit card. When a customer makes a payment in a conventional reaffirmation credit card, the payment is divided between the account records in proportion to the outstanding balance of each account record. Prior to the customer making a payment (as shown in block 40), the balance in account record 12 is $300 and the balance in account record 14 is $200. In block 50, the customer makes a payment of $200. Because the balance of the account records is not the same, the payment is allocated proportionally, with ⅗ of the payment going to account record 12 and the remainder to account record 14.

While the above reaffirmation credit card system gives an incentive to customers of charged-off accounts to reaffirm their debts in return for obtaining a credit card, the system merely gives a line of credit equal to a portion of the payment made by the customer. This may not give much incentive to many customers. In particular, the customer is simply getting to use the money they have recently put in, not unlike a secured credit card.

Normally, with customers who pay their credit cards in an acceptable manner, the debt-holder makes money from the fees and/or interest charged to the customer for using the card. In a conventional reaffirmation credit card, the debt-holder makes money from the payments the customer makes towards the balance in pre-existing debt account record 14. This is true because of how a reaffirmation card is structured. Consider a customer has a pre-existing debt of $1000. The current debt-holder may have purchased this debt from the original credit issuer for $100, or ten cents on the dollar. The reaffirmation credit card is structured so that one-half of the customer's debt is considered the available credit line (credit line account record 12) and one-half is considered pre-existing debt (pre-existing debt account record 14). If the debt-holder is able to obtain payment of any amount over $100 on the pre-existing debt account record, the debt-holder makes money. The one-half of the pre-existing debt that is transferred to account record 12 is written off in the cash accounting system used by many debt-holders. This amount then is already considered lost by the debt-holder. When a customer makes a payment that is allocated to account record 12, the debt-holder is receiving money that it did not expect to receive. Therefore, when the debt-holder extends a line of credit equal to the amount of payments made to account record 12, the debt-holder is essentially providing the customer access to money it did not expect to receive.

In this type of system, however, the debt-holder realizes a greater risk if the debt-holder offers a line of credit greater than the payment amount the customer has made toward the credit line account record 12. The amount in the credit-line account record is an amount that is written off by the debt-holder. Should the customer make payments, the debt-holder is realizing “unexpected” payment on an amount that is written off. It is this unexpected amount that is offered to the customer as credit. If the debt-holder were instead to offer an amount greater than the unexpected payment, the debt-holder may be increasing the amount of money it is forced to write-off if the customer charges and does not pay. This risk is often not acceptable.

Accordingly, there is a need for an improved system and method for offering a incentive to reaffirm a pre-existing charged-off debt without increasing the amount of risk assumed by the debt-holder.

### SUMMARY OF THE INVENTION

Systems and methods consistent with the principles of the present invention provide a reaffirmation credit card that gives a customer a greater incentive to reaffirm the debt without increasing the amount of risk assumed by the debt-holder.

Specifically, systems and methods consistent with the present invention manage a reaffirmation credit card account associated with an outstanding debt of a user. The reaffirmation credit card account includes a credit line account record, providing an available credit up to a credit limit, and a pre-existing debt account record. The outstanding debt of the user is transferred to the pre-existing debt account record. When a payment to the reaffirmation credit card account is received from the user, the payment is allocated between the credit line account record and the pre-existing debt account record, based on predetermined allocation criteria. The amount of available credit in the credit line account record is increased, based on whether the received payment or series of payments satisfies predetermined payment criteria.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general summary and the following detailed description are exemplary and explanatory only and are not restrictive of the invention, as claimed. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments of the present invention and, together with the description, serve to explain the principles of the invention. In the drawings:

FIG. 1 is a diagram illustrating a conventional reaffirmation credit card account;

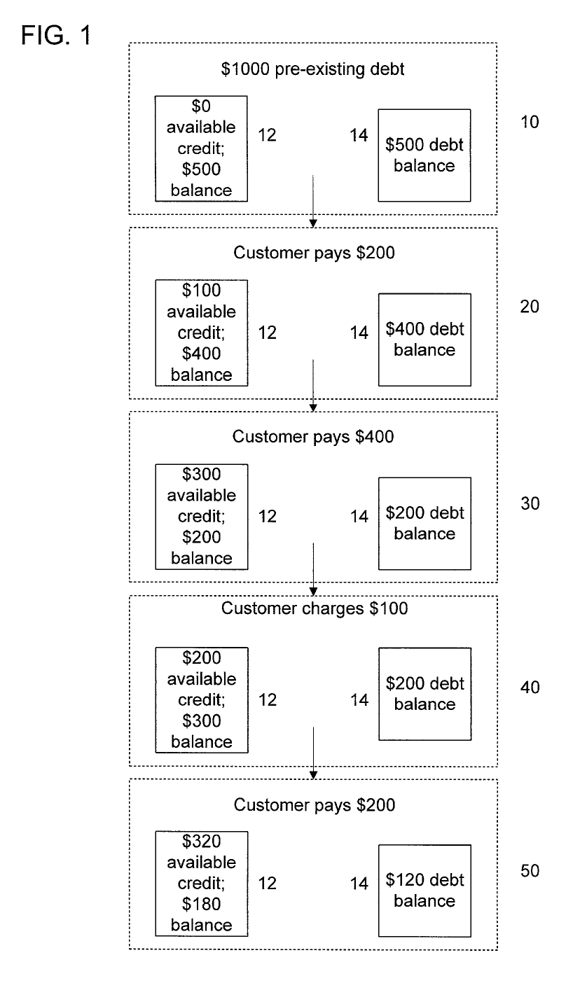

FIG. 2 is an exemplary block diagram of a system for managing a reaffirmation credit card account consistent with the principles of the present invention;

FIG. 3 is an exemplary flow chart of a method, consistent with the principles of the present invention, for managing a reaffirmation credit card account; and

FIG. 4 is a diagram illustrating a reaffirmation credit card account consistent with the present invention.

### DETAILED DESCRIPTION

Systems and methods consistent with the present invention provide an incentive to customers to reaffirm their overdue outstanding debt, thereby improving the debt recovery by the debt-holders, while still realizing acceptable risk for the debt-holder. The greater incentive to reaffirm includes an initial available credit line greater than the amount of payment made by the customer as well as periodic credit limit increases, chances of debt-recovery while retaining the same amount of risk as was present for the conventional reaffirmation credit card.

Generally, systems and methods consistent with the present invention include creating a new account for a customer including two account records, a credit line account record and a pre-existing debt account record. The system transfers the customer's pre-existing charged-off debt to the pre-existing debt account record. Based on some criteria, the system provides the customer with a credit card having an initial available credit line. For example, these criteria may include the amount of pre-existing debt transferred. As the customer makes payments, the system determines if the customer is eligible for a credit limit increase, based on a different set of criteria. For example, these criteria may include paying a certain amount towards the pre-existing debt.

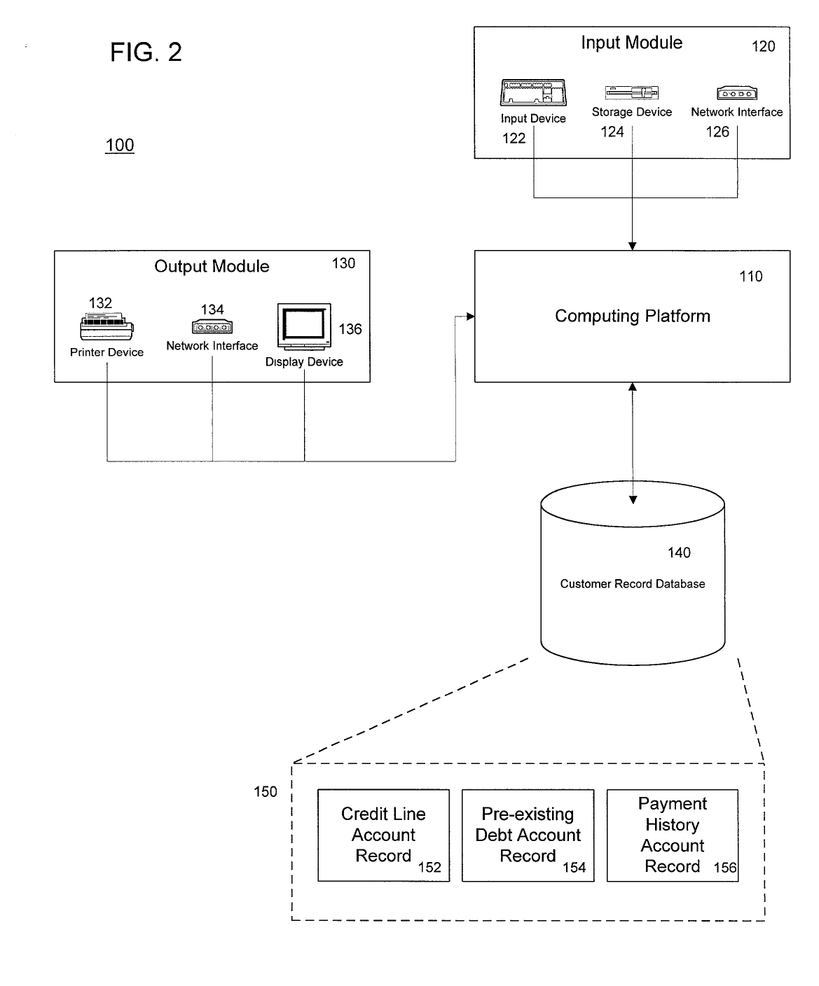

By way of a non-limiting example, FIG. 2 illustrates a system environment 100 for implementing the features and principles consistent with the present invention. As illustrated in FIG. 2, the system 100 includes a computing platform 110, an input module 120, an output module 130, and a customer record database 140. Customer record database 140 further includes customer account records 150.

Computing platform 110 is adapted to process the outstanding debt and payment information received from input module 120. Computing platform 110 is further adapted to provide billing statements and other account information to output module 130. Additionally, computing platform 110 accesses information in customer record database 140 to determine whether the customer is eligible for a credit limit increase, and, if so,

Computing platform 110 preferably comprises a personal computer or mainframe computer for performing various functions and operations of the invention. Computing platform 110 may be implemented, for example, by a general purpose computer selectively activated or reconfigured by a computer program stored in the computer, or may be a specially constructed computing platform for carrying-out the features and operations of the present invention. Computing platform 110 may also be implemented or provided with a wide variety of components or subsystems including, for example, one or more of the following: one or more central processing units, a co-processor, memory, registers, and other data storage and/or processing devices and subsystems.

Input module 120 further includes an input device 122, a storage device 124, and/or a network interface 126. Input device 122 may include a keyboard, mouse, or other data entering devices. Storage device 124 may include a disk drive, optical drive, or CD-ROM. Network interface 126 may receive information over any type of network (not shown), such as a telephony-based network (e.g., PBX or POTS), a local area network, a wide area network, a dedicated intranet, and/or the Internet.

Input module 120 may be used to enter or obtain information about the customer, the customer's outstanding debt on an account, and/or payments or charges made by the customer to the account. For example, when creating a new reaffirmation account, information entered or obtained by input module 120 may include the customer's name, address, telephone number, or Social Security number. Input module 120 may also be used to obtain or enter information about the outstanding debt of the original account, such as the original holder of the debt, the amount of the debt, the length of delinquency on the debt, or other collection attempt information. For example, this information may be transferred from the original holder of the debt or may be entered manually by personnel of the debt-holder.

After a new reaffirmation account has been created and the customer has been issued a reaffirmation credit card, input module 120 may be used to input or obtain transaction information about the reaffirmation credit card. This transaction information may include the amount of the customer's last payment, the date of the customer's last payment, the amount charged by the customer, and the provider of goods or services to whom the charge was made. Input module 120 forwards the received information to computing platform 110, for storage in customer record database 140. As described below, computing platform 110 then uses the stored account information to manage the customer's account and determine whether the customer is eligible for a credit limit increase.

Computing module 110 provides reaffirmation account information generated by computing module 110 or obtained from customer record database 140 to output module 130. Output module 130 outputs the reaffirmation account information to the customer or to personnel of the debt-holder for use internally or for assisting the customer. This reaffirmation account information may include the minimum payment amount due, the pre-existing debt balance, the amount of credit available, and the amount of payment required to obtain a credit limit increase. Output module 130 further includes a printer device 132, a network interface 134, and/or a display device 136. Printer device 132 may be used to provide a conventional billing statement to the customer. Network interface 134 may provide billing and other information to the 135 may provide account information to a customer service representative of the debt-holder who is assisting the customer via telephone.

Customer record database 140 stores customer account records 150. Each customer account record 150 preferably includes a credit line account record 152, a pre-existing debt account record 154, and a payment history account record 156, as well as other identifying information concerning the customer and the reaffirmation account. Credit line account record 152 stores information concerning the amount of credit available to the customer, the maximum amount of credit that the customer is eligible to receive, the current credit line balance, and/or the amount of charges the customer has made. Pre-existing debt account record 156 stores information concerning the outstanding debt of the customer, such as information about the pre-existing debt balance and the original debt-holder of that debt. Payment history database 154 stores information about payments made to the debt-holder by the customer. This payment information includes, for example, the amount of the payment, the date the payment was made, the date the payment was due, and/or how the payment was allocated between the credit line balance (stored in credit line account record 152) and the pre-existing debt balance (stored in pre-existing debt account record 154).

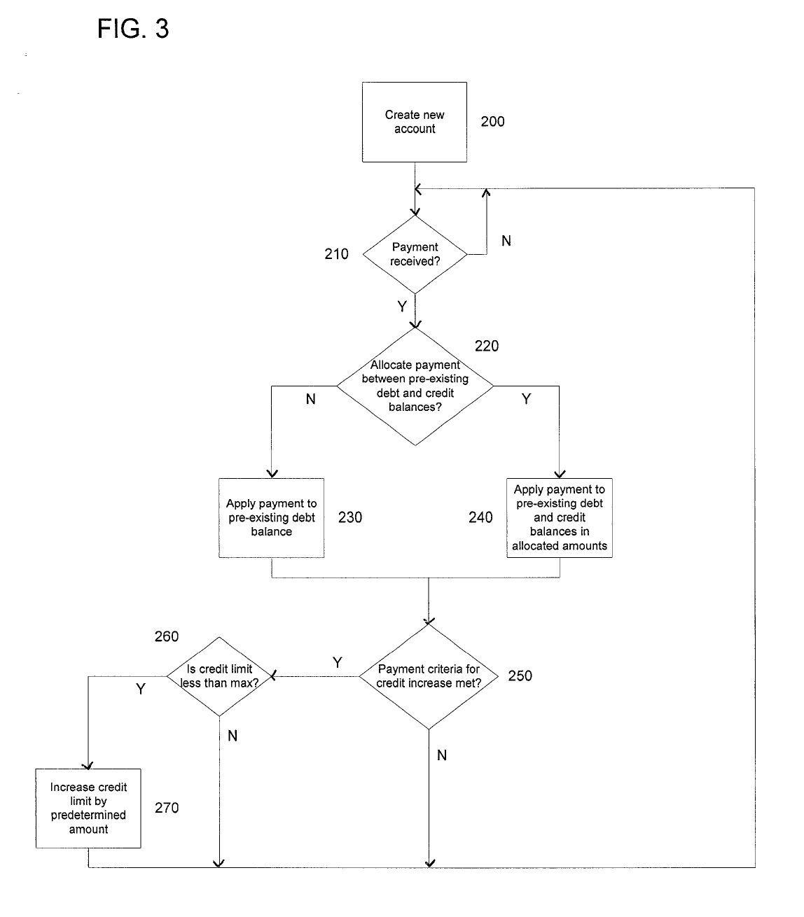

In accordance with the principles of the present invention, an exemplary process for providing a reaffirmation credit card including an increasing credit limit will now be described with reference to FIG. 3.

FIG. 3 illustrates an exemplary method for managing a reaffirmation credit card, consistent with the principles of the present invention. First, the system 100 creates a new account (step 200). Creating a new account may involve identifying and soliciting potential customers, gathering necessary information about those customers, creating customer account records, transferring a customer's outstanding overdue debt to the new reaffirmation account, and providing each customer with a reaffirmation credit card.

Identifying potential customers may be done in a number of ways. The system may identify potential customers based on criteria to determine which customers are likely to accept the offer of a reaffirmation credit card. For example, the system may identify customers who do not have a significant length of payment delinquency. Alternatively, the system may identify customers who have an outstanding overdue debt that falls within a range of acceptable debt. In this case, the reaffirmation credit card may be offered to potential customers who have between $300 and $11,000 in pre-existing debt.

After identifying potential customers, solicitation may also take on a number of forms, such as by targeted or blind solicitation, via electronic mail, regular mail, telephone, or other forms of advertisement. Often, the business offering the reaffirmation credit card may be a purchasing agency that buys charged-off debts from other credit issuers for a fraction of the outstanding debt. In this case, for example, the purchasing agency may solicit the potential customers based on information received from the original credit issuers.

After a customer accepts the offer and reaffirms the outstanding overdue debt by agreeing to pay the debt in exchange for a credit card, the system gathers the customer identifying information and information on the original account. In some cases, this information may be readily available to the debt-holder from the information provided by the original credit-issuer. In other cases, the customer may need to provide this information. The original account information may include information about the pre-existing debt, such as the amount of outstanding overdue debt, the original credit-issuer, or the length of delinquency in payments to the original account. After the system obtains this information, an account is created for the customer. The system creates customer account record 150 including a credit line account record 152, a pre-existing debt account record 154, and a payment history account record 156.

After the new account is created, the system transfers the customer's outstanding overdue debt from the original account and stores information about the pre-existing debt in the pre-existing debt account record 154. In systems consistent with the present invention, the entire pre-existing debt balance may be allocated to the pre-existing debt account record 154.

Following transfer of the debt, the system provides the customer with a reaffirmation credit card. Computing platform 110 determines an amount of available credit for the reaffirmation credit card associated with credit account record 152. For example, in one embodiment, the initial amount of available credit is dependent on the amount of transferred debt. For instance, an available credit of $50 may be awarded if the amount of pre-existing debt transferred is less than $2000, but up to $100 if greater than this amount. Alternatively, computing platform 110 may determine that the initial amount of available credit is $0 until the customer meets certain payment criteria. When the customer makes a payment or series of payments that meet the predetermined threshold payment criteria, the credit available on the reaffirmation credit card increases. For example, initially the system may provide the customer with a credit card including $0 of available credit. After the customer makes a payment of $100, the system may increase the available credit on the reaffirmation credit card from $0 to $200. This process is similar to the process involved with credit limit increases, and is described in detail below with respect to steps 250-270.

Once the customer has been provided with a reaffirmation credit card, the system may enter a period of billing cycles, similar to a conventional credit card. A billing cycle may occur monthly, as is conventional, but may also occur as determined by the system. A statement may be sent to the customer at the end of each billing cycle and may include a conventional paper-based statement, mailed to the customer before the due date of the payment. Alternatively, the statement may be Internet-based, either available on a website or sent to the customer via e-mail. In any case, the statement may include information about the amount of payment due, the due date of the payment, the amount of available credit, the respective balances of the credit line account record and the pre-existing debt account record, and any other information that may assist the customer. The statement also may inform the customer what action to take in order to obtain a credit limit increase. For example, the system may require that payments exceed a predetermined threshold before increasing the credit limit or the available credit in the credit line account. In this case, the monthly statement may include information about the customer's progress towards the satisfaction of these criteria. Thus, if payments must reach $100 before increasing the credit limit, and the last payment made by the customer was $20 towards the pre-existing debt balance, then the statement may state that, “A payment of $80 toward the pre-existing debt balance will result in a credit limit increase.”

After providing the customer with a billing statement, the system awaits receipt of payment from the customer (step 210). Once the system determines that payment has been received, computing platform 110 determines whether to allocate payment between the credit line and pre-existing debt account records 152 and 154 (step 220). If the customer has made any charges to the reaffirmation credit card that have not yet been paid for, payment will be allocated between the records 152 and 154. If computing platform 110 determines that there is no balance in the credit line account record 152, computing platform 110 applies the payment made by the customer to the pre-existing debt account record 154 (step 230). However, if computing platform 110 determines there is a balance in the credit line account record 152, the payment made by the customer will be applied to both the pre-existing debt account record 154 and the credit line account record 152 in allocated amounts (step 240).

This allocation may be done in a number of ways. For example, computing platform 110 may apportion the payment between the account records 152 and 154 based on the current balance of each record. In this case, if the credit line account record 152 included a $20 balance and the pre-existing debt account record 154 included an $80 balance, then ⅕of the payment would be applied to record 152 and ⅘would be applied to record 154. Computing platform 110 preferably determines the allocation at the time of each payment. Alternatively, computing platform 110 may predetermine the proportion allocated to each account record. For example, regardless of the balances in the account records, the computing platform may allocate the payments equally or according to another predetermined proportion.

Following either application of the payment towards the pre-existing debt (step 230) or allocation of the payment between the account records (step 240), computing platform 110 next determines whether the customer is eligible for a credit line increase based on whether certain payment criteria has been satisfied (step 250). In order to increase the available credit line, the payment criteria preferably requires that a payment (or series of payments since the last increase) exceed a certain threshold amount, such as $100. Computing platform 110 preferably makes this determination based on payments allocated to pre-existing debt account record 154; however, total payment amounts may also be considered. The threshold amount may also increase or decrease as the amount of pre-existing debt decreases. For example, in order to obtain a first credit limit increase, the system may require a payment of at least $200. Subsequent credit limit increases may only require a payment of $100 each. Alternatively, the payment criteria may include determining whether the customer has made a certain number of on-time payments, such as making four timely monthly payments of at least the minimum payment due.

If the customer has not met the payment criteria for obtaining a credit limit increase, the process returns to step 210 to await another payment. Also, if the customer has not met the payment criteria, the system may accumulate payment information until the payment criteria is satisfied. For example, a system may include the payment criteria that $100 be paid towards pre-existing debt account record 154 to obtain a credit limit increase. The customer makes five payments of $20 towards pre-existing debt account record 154. In this case, the system may accumulate information determine that the payment criteria are met and award a credit limit increase. The customer's next billing statement may include a statement about the customer's progress towards the credit limit increase as described above.

If computing platform 110 determines the customer is eligible for a credit limit increase, the computing platform 110 next determines if the customer's current credit limit is less than the maximum (step 260). In one embodiment of the present invention, the maximum possible credit line available to the customer is one-half of the pre-existing debt transferred to the reaffirmation account. Computing platform 110, however, may determine the maximum possible credit line using other criteria, such as how quickly the customer makes payments to the account. In any event, computing platform 110 will increase credit available on the customer's reaffirmation credit card by a predetermined amount as long as the credit limit does not exceed the maximum (step 270). For example, in one embodiment of the system, a customer may obtain a $50 credit limit increase upon every payment of $100 to the pre-existing debt balance account record 154, up to the maximum credit line available. After increasing the customer's credit line, the process ends until the next payment is received. Further, the customer's next billing statement may indicate the increase in credit available.

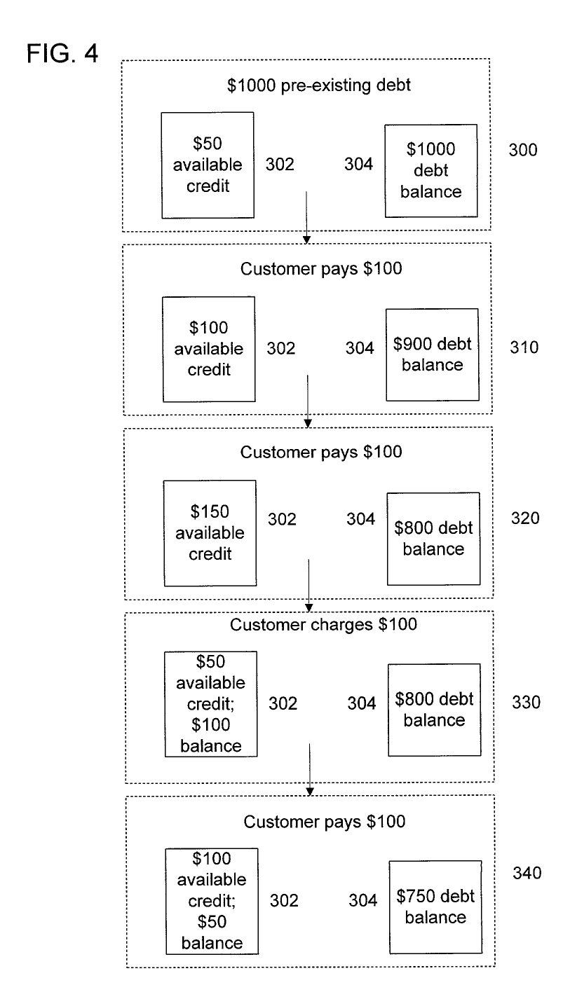

FIG. 4 illustrates an exemplary flow diagram of events in a system consistent with the principles of the present invention. (Again, note that in FIG. 4, interest and fees are ignored for simplicity.) Beginning in block 300, the customer enters the system with a $1000 pre-existing debt. The system transfers this pre-existing debt to pre-existing debt account record 304. Consistent with one embodiment described above, the system provides the customer with a reaffirmation credit card, including an initial available credit line of $50, as shown in credit line account record 302.

In block 310, the customer makes a payment of $100. Because the customer has no balance in credit line account record 302, the system applies the full payment of $100 to the customer's pre-existing debt balance, as shown in account record 304. In this embodiment, the customer is entitled to a credit limit increase upon paying $100 towards the pre-existing debt balance. Because the customer has met this payment criteria here, the system increases the credit limit on the reaffirmation credit card from $50 to $100, as shown in account record 302.

Similarly, in block 320, the customer again has no outstanding balance in credit account record 302. Thus, the full payment of $100 is applied to the pre-existing debt in account record 304. Accordingly, the customer receives a $50 credit limit increase.

In block 330, the customer charges $100 to the reaffirmation credit card. Accordingly, the balance on the credit line account record 302 increases to $100, leaving a remaining $50 of available credit for further use. The customer has made no payments in block 330, so the balance in pre-existing debt account record 304 remains at $800.

In block 340, the customer makes a payment of $100. Because the customer now has a balance in credit line account record 302, the computing platform 110 allocates the payment. For this example, the payment is allocated equally between records 302 and 304. Thus, $50 is applied to credit line account record 302, decreasing the balance to $50 and increasing the available credit to $100, and $50 is applied to pre-existing debt account record 304. Even though the customer made a payment of $100, as in blocks 320 and 330, the system does not award the customer with a credit limit increase, because only $50 is allocated to the pre-existing debt account record 304. The customer, however, may be eligible for a credit limit increase with the next payment made to the debt-holder, as long as $50 or more of the payment is allocated towards the pre-existing debt account record 304. This $50 or more will be accumulated with the $50 allocated to record 304 in block 340, thus satisfying the payment criteria for a credit limit increase.

While this invention has been described in the context of reaffirmation credit cards, other implementations are possible. For example, a customer with a negative credit history may be offered a loan. Accompanying this loan, as an incentive to make payments, the customer may be offered a credit card, structured like the reaffirmation credit card described above. The amount of the recent loan to the customer becomes the pre-existing debt. As the customer makes payments towards the pre-existing debt, or recent loan, the customer becomes eligible for credit limit increases, as described.

The above-noted features and other aspects and principles of the present invention may be implemented in various systems or network environments to provide automated computational tools for managing the account records and performing tests to determine if various criteria are met. Such environments and applications may be specifically constructed for performing various processes and operations of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

It will be apparent to those skilled in the art that various modifications and variations can be made to the invention without departing from the scope or spirit of the invention. For example, criteria other than the amount of pre-existing debt remaining to be paid, the total amount of payments made, or number of months of on-time payment may be used to determine whether the customer is entitled to a credit limit increase.

Other modifications and embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

What is claimed is:

1. A method for managing a reaffirmation credit card account associated with an outstanding debt of a user, wherein the reaffirmation credit card account further includes a credit line account record and a pre-existing debt account record, and wherein the credit line account record provides an available credit up to a credit limit, said method comprising:
transferring the outstanding debt into the pre-existing debt account record;
receiving a payment to the reaffirmation credit card account from the user;
allocating the payment between the credit line account and the pre-existing debt account based on predetermined allocation criteria; and
increasing the amount of available credit in the credit line account record, based on whether the received payment satisfies predetermined payment criteria.

2. A method according to claim 1, wherein the step of transferring the outstanding debt comprises:
providing an initial amount of available credit in the credit line account record.

3. A method according to claim 2, wherein the initial amount of available credit in the credit line account is based on the amount of outstanding debt transferred.

4. A method according to claim 1, wherein the step of transferring the outstanding debt comprises:
receiving an initial payment from the user;
determining if the initial payment is greater than a predetermined payment threshold value; and
providing an initial amount of available credit in the credit line account record, wherein the initial amount of available credit is greater than the initial payment received from the user.

5. A method according to claim 1, wherein the credit line account record may have a balance due from charges made by the user and wherein the step of allocating the payment includes the steps of:
determining if a balance due is present in the credit line account;
applying the received payment to the pre-existing debt balance when determining that the credit line account record does not have a balance due; and
applying the payment to the credit line account and the pre-existing debt account according to the predetermined allocation criteria when determining that the credit line account record does have a balance due.

6. A method according to claim 5, wherein the step of applying the payment to the credit line account and the pre-existing debt account further includes:
determining a proportion of the received payment to allocate to the pre-existing debt account record based on the balance of both the pre-existing debt account record and the credit line account record;
allocating the determined proportion of the received payment to the pre-existing
allocating a remainder of the received payment to the credit account record.

7. A method according to claim 5, wherein the predetermined allocation criteria include applying predetermined proportions of the received payment to the pre-existing debt and the credit line account records.

8. A method according to claim 1, wherein the step of increasing the amount of available credit includes:
determining whether the payment received is greater than a predetermined threshold payment value; and
increasing the available credit when determining that the payment is greater than the threshold payment value.

9. A method according to claim 8, wherein the predetermined threshold payment value is based on the balance of the pre-existing debt account record.

10. A method according to claim 1, wherein the step of increasing the amount of available credit includes:
determining whether a predetermined number of timely payments have been received; and
increasing the available credit when determining that the predetermined number of timely payments have been received.

11. A method according to claim 1, wherein the step of increasing the amount of available credit includes:
increasing the amount of available credit by an amount greater than the amount of payment made towards the credit line account record.

12. A computer for managing a reaffirmation credit card account, the computer comprising:
a memory having program instructions; and
a processor, responsive to the programming instructions, configured to:
transfer the outstanding debt into the pre-existing debt account record;
receive a payment to the reaffirmation credit card account from the user;
allocate the payment between the credit line account and the pre-existing debt account based on predetermined allocation criteria; and
increase the amount of available credit in the credit line account record, based on the whether the received payment satisfies predetermined payment criteria.

13. The computer of claim 12, wherein the instruction to transfer the outstanding debt further includes instruction to:
provide an initial amount of available credit in the credit line account record.

14. The computer of claim 13, wherein the initial amount of available credit in the credit line account is based on the amount of outstanding debt transferred.

15. The computer of claim 12, wherein the instruction to transfer the outstanding debt further includes instruction to:
receive an initial payment from the user;
determine if the initial payment is greater than a predetermined payment threshold value; and
provide an initial amount of available credit in the credit line account record, wherein the initial amount of available credit is greater than the initial payment received from the user.

16. The computer of claim 12, wherein the credit line account record may have a balance due from charges made by the user and wherein the instruction to allocate the payment further includes instruction to:
determine if a balance due is present in the credit line account;
apply the received payment to the pre-existing debt balance when determining that the credit line account record does not have a balance due; and
apply the payment to the credit line account and the pre-existing debt account according to the predetermined allocation criteria when determining that the credit line account record does have a balance due.

17. The computer of claim 16, wherein the instruction to apply the payment to the credit line account and the pre-existing debt account further includes instruction to:
determine a proportion of the received payment to allocate to the pre-existing debt account record based on the balance of both the pre-existing debt account record and the credit line account record;
allocate the determined proportion of the received payment to the pre-existing debt account record; and
allocate a remainder of the received payment to the credit account record.

18. The computer of claim 16, wherein the predetermined allocation criteria include applying predetermined proportions of the received payment to the pre-existing debt and the credit line account records.

19. The computer of claim 12, wherein the instruction to increase the amount of available credit further includes instruction to:
determine whether the payment received is greater than a predetermined threshold payment value; and
increase the available credit when determining that the payment is greater than the threshold payment value.

20. The computer of claim 12, wherein the instruction to increase the amount of available credit further includes instruction to:
determine whether a predetermined number of timely payments have been received; and
increase the available credit when determining that the predetermined number of timely payments have been received.

21. The computer of claim 12, wherein the instruction to increase the amount of available credit further includes instruction to:
increase the amount of available credit by an amount greater than the amount of payment made towards the credit line account record.

22. A system for managing a reaffirmation credit card account associated with an outstanding debt of a user, wherein the reaffirmation credit card account further includes a credit line account record and a pre-existing debt account record, and wherein the credit line account record provides an available credit up to a credit limit, said system comprising:
means for transferring the outstanding debt into the pre-existing debt account record;
means for receiving a payment to the reaffirmation credit card account from the user;
means for allocating the payment between the credit line account and the pre-existing debt account based on predetermined allocation criteria; and
means for increasing the amount of available credit in the credit line account record, based on the whether the received payment satisfies predetermined payment criteria.

23. A system according to claim 22, wherein the means for transferring the outstanding debt comprises:
means for providing an initial amount of available credit in the credit line account record.

24. A system according to claim 23, wherein the initial amount of available credit in the credit line account is based on the amount of outstanding debt transferred.

25. A system according to claim 22, wherein the means for transferring the outstanding debt comprises:
means for receiving an initial payment from the user;
means for determining if the initial payment is greater than a predetermined payment threshold value; and
means for providing an initial amount of available credit in the credit line account record, wherein the initial amount of available credit is greater than the initial payment received from the user.

26. A system according to claim 22, wherein the credit line account record may have a balance due from charges made by the user and wherein the means for allocating the payment includes:
means for determining if a balance due is present in the credit line account;
means for applying the received payment to the pre-existing debt balance when
means for applying the payment to the credit line account and the pre-existing debt account according to the predetermined allocation criteria when determining that the credit line account record does have a balance due.

27. A system according to claim 26, wherein the means for applying the payment to the credit line account and the pre-existing debt account further includes:
means for determining a proportion of the received payment to allocate to the pre-existing debt account record based on the balance of both the pre-existing debt account record and the credit line account record;
means for allocating the determined proportion of the received payment to the pre-existing debt account record; and
means for allocating a remainder of the received payment to the credit account record.

28. A system according to claim 26, wherein the predetermined allocation criteria include applying predetermined proportions of the received payment to the pre-existing debt and the credit line account records.

29. A system according to claim 22, wherein the means for increasing the amount of available credit includes:
means for determining whether the payment received is greater than a predetermined threshold payment value; and
means for increasing the available credit when determining that the payment is greater than the threshold payment value.

30. A system according to claim 22, wherein the means for increasing the amount of available credit includes:
means for determining whether a predetermined number of timely payments have been received; and
means for increasing the available credit when determining that the predetermined number of timely payments have been received.

31. A system according to claim 22, wherein the means for increasing the amount of available credit includes:
means for increasing the amount of available credit by an amount greater than the amount of payment made towards the credit line account record.

32. A method for establishing and managing a reaffirmation credit card account associated with an outstanding debt of a user, said method comprising:
creating a credit line account record without any outstanding debt, the credit line account record providing an available credit up to a credit limit;
creating a pre-existing debt account record;
transferring the outstanding debt into the pre-existing debt account record;
receiving a payment to the reaffirmation credit card account from the user;
allocating the payment between the reaffirmation credit card account and the pre-existing debt account based on predetermined allocation criteria; and
increasing the amount of available credit in the credit line account record, based on whether the received payment satisfies predetermined payment criteria.

33. A method according to claim 32, wherein the step of creating a credit line account record comprises:
providing an initial amount of available credit in the credit line account record.

34. A method according to claim 33, wherein the initial amount of available credit in the credit line account is based on the amount of outstanding debt transferred.

35. A method according to claim 32, wherein the credit line account record may have a balance due from charges made by the user and wherein the step of allocating the payment includes the steps of:
determining if a balance due is present in the credit line account;
applying the received payment to the pre-existing debt balance when determining that the credit line account record does not have a balance due; and
applying the payment to the credit line account and the pre-existing debt account according to the predetermined allocation criteria when determining that the credit line account record does have a balance due.

36. A method according to claim 32, wherein the step of increasing the amount of available credit includes:
determining whether the payment received is greater than a predetermined threshold payment value; and
increasing the available credit when determining that the payment is greater than the threshold payment value.
